(19) United States
(12) Patent Application Publication
(10) Pub. No.: US 2021/0334694 A1
(43) Pub. Date: Oct. 28, 2021

(54) PERTURBED RECORDS GENERATION

(71) Applicant: International Business Machines Corporation, Armonk, NY (US)

(72) Inventors: Lukasz G. Cmielowski, Krakow (PL); Rafal Bigaj, Kracow (PL); Maksymilian Erazmus, Zasow (PL); Wojciech Sobala, Krakow (PL)

(21) Appl. No.: 16/859,013

(22) Filed: Apr. 27, 2020

(51) Int. Cl. G06N 20/00; G06N 5/02; G06K 9/62; G06F 17/15; G06F 17/16

(52) U.S. Cl. CPC G06N 20/00; G06N 5/02; G06F 17/16; G06K 9/6267; G06F 17/15; G06K 9/6256

(57) ABSTRACT

Reducing a count of perturbed records in a machine learning dataset by application of a correlation matrix of feature values identified in training records to reduce the number of features represented in the perturbed records. Deleting one of a pair of correlated records is achieved with reference to a correlation score that identifies features of sufficient similarity to be paired up. Reducing the number of features for which values are assigned in a data perturbation process results in a relatively reduced number of perturbed records.

### BACKGROUND

The present invention relates generally to the field of machine learning, and more particularly to perturbed records generation.

Machine learning, a subset of tools used in the artificial intelligence field, is the scientific study of algorithms and statistical models that computer systems use to perform a specific task without using explicit instructions, relying instead on patterns and inference. Machine learning is closely related to computational statistics, which focuses on making predictions using computers. The study of mathematical optimization delivers methods, theory, and application domains to the field of machine learning. Data mining is a field of study within machine learning that focuses on exploratory data analysis through unsupervised learning. In its application across business problems, machine learning is also referred to as predictive analytics.

Machine learning algorithms build a mathematical model based on sample data, known as training data, to make predictions or decisions without being explicitly programmed to perform the task. Machine learning algorithms are used in a wide variety of applications such as email filtering and computer vision where conventional algorithms fall short in effectively performing the task.

Machine learning models are developed using multiple datasets, namely training datasets, validation datasets, and test datasets. Typically, validation datasets are processed by a fitted model and test datasets are processed by a final model fit on a training dataset. Records, as the term is used herein, are the observations provided in the various datasets that prompt a response by machine learning models, whether fitted models or final models.

### SUMMARY

According to an aspect of the present invention, there is a method, computer program product and/or system for feature correlation in data perturbation that performs the following operations (not necessarily in the following order): (i) obtains a set of structured data including individual records having a set of data features and corresponding data values, wherein processing the set of structured data by a machine learning model results in a proposed action corresponding to an individual record; (ii) generates a correlation matrix incorporating the set of data features and the corresponding data values; (iii) identifies, with reference to the correlation matric, a set of data feature pairs as duplicative of one another according to a correlation criterion; (iv) removes, from the set of data features, one data feature of each identified data feature pair to generate a reduced dataset; (v) a set of perturbed records for arbitrary indicator identification based on value variances for a target data feature of the reduced dataset, the arbitrary indicator identification being a test of the machine learning model; and (vi) determines, according to the set of perturbed records, a set of arbitrary indicators associated with the proposed action corresponding to the individual record.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a block chart generated by the first embodiment system.

### DETAILED DESCRIPTION

Some embodiments of the present invention are directed to reducing a count of perturbed records in a machine learning dataset by application of a correlation matrix of feature values identified in training records to reduce the number of features represented in the perturbed records. Deleting one of a pair of correlated records is achieved with reference to a correlation score that identifies features of sufficient similarity to be paired up. Reducing the number of features for which values are assigned in a data perturbation process results in a relatively reduced number of perturbed records.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

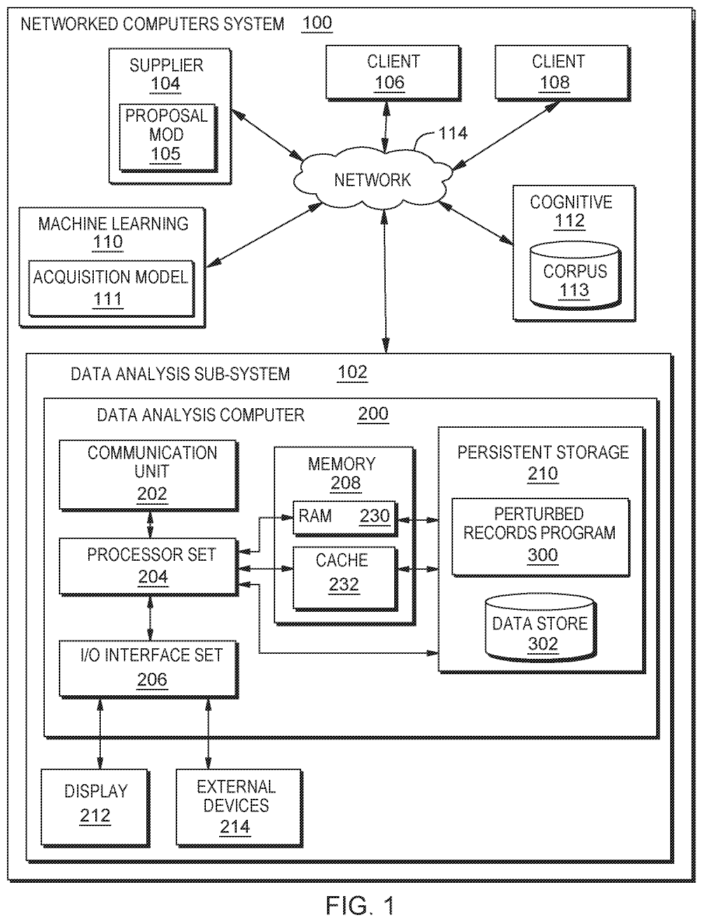

As shown in FIG. 1, networked computers system 100 is an embodiment of a hardware and software environment for use with various embodiments of the present invention. Networked computers system 100 includes: data analysis subsystem 102 (sometimes herein referred to, more simply, as subsystem 102); supplier subsystem 104; proposal mod 105; client subsystems 106 and 108; machine learning subsystem 110; material acquisition model 111; cognitive computing system 112; domain-specific knowledge corpus 113; and communication network 114. Data analysis subsystem 102 includes: data analysis computer 200; communication unit 202; processor set 204; input/output (I/O) interface set 206; memory 208; persistent storage 210; display 212; external device(s) 214; random access memory (RAM) 230; cache 232; perturbed records program 300; and data store 302.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

Monitoring the output of machine learning models for characteristics that demonstrate bias is essentially based on generating perturbed records, or observances, having altered data feature value(s) for further processing. The generation of perturbed records is referred to as data perturbation. Perturbed records are generated from a set of unique values available to various features of a structured dataset. The goal of perturbed records is to generate records conforming to the structured data used by the machine learning model while covering many of the value variances available to a given feature of the structured data. The perturbed records are processed by a machine learning model so that the output can be observed for bias behavior in view of a feature or specific feature value. The amount of perturbed records generated in this way can be enormous. For black box models, deployment of perturbed records should make as few scoring requests as possible, a scoring request being each submission of a perturbed record for evaluation. With perturbed records the typical record footprint can be very large.

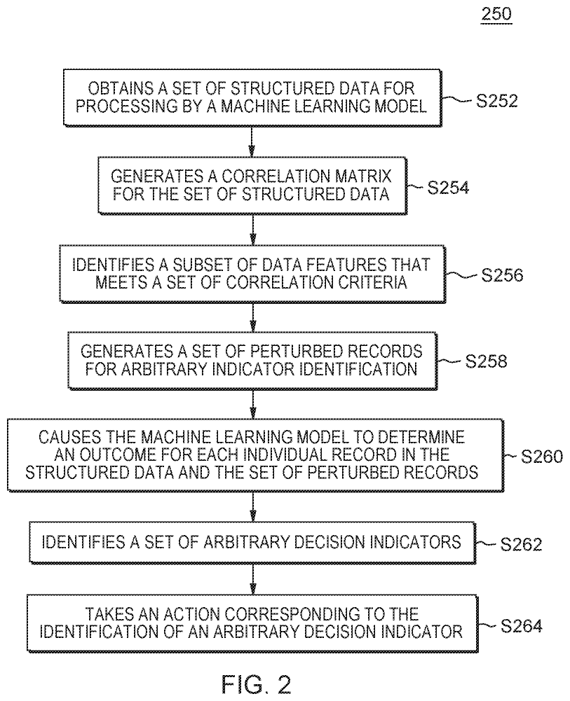

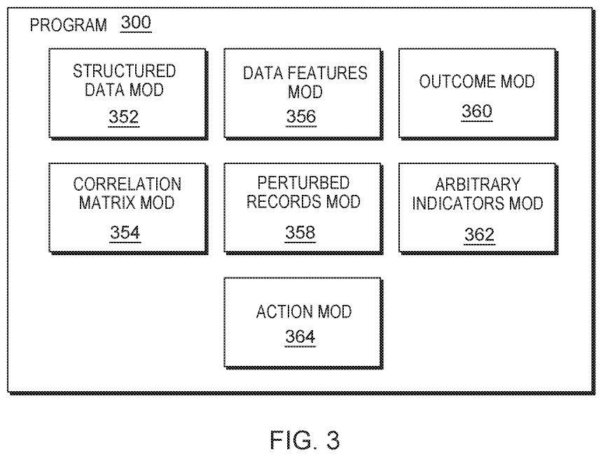

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation 5252, where structured data module (“mod”) 352 obtains a set of structured data including examples and observations for processing by a machine learning model. The structured data includes individual records that associate feature elements with specific values relevant to an inquiry for a machine learning model to answer or predict an outcome in support of an action to be taken. Oftentimes, a feature element is amenable to being associated with a range of values. The specific value of a feature in the set of structured data acts as a real-world, or commercially viable, value for which a determination is to be made by machine learning model. In this example, material acquisition model 111 (FIG. 1), a machine learning model, uses features including supplier name, brand name, and warehouse location as input fields. Feature values assigned to the various features according to the set of structured data represent actual values for a commercial instance of a potential material acquisition decision. The structured data from supplier proposals, such as delivered by proposal mod 105 of supplier sub-system 104. The data obtained from various supplier makes up the set of structured data, which is stored in data store 302. The features and their values described herein are merely for illustration purposes. Any data features for which various values may be assigned are suitable for data perturbation in a machine learning environment.

Processing proceeds to operation 5254, where correlation matrix mod 354 generates a correlation matrix for the set of structured data. A set of features within the structured data obtained by structured data module 352, such as supplier name, brand name, and warehouse location is used to generate the categories, or headers, of correlation matrix. For each feature, a set of corresponding values provided in the set of structured data are grouped together. The correlation matrix mod populates the matrix with comparative values, or scores, for the two intersecting features. See Table 1, in the FURTHER COMMENTS AND/OR EMBODIMENTS section of this disclosure. For example, when the two intersecting features are the same, the comparison score is 1.000 because the data values of the features are the exact same values. Alternatively, other features (other than supplier name, brand name, and warehouse location) and corresponding values are used to generate the matrix. The correlation matrix is executed within program 300 of server computer 200 shown in FIG. 1.

Processing proceeds to operation 5256, where data features mod 356 identifies a subset of data features that meets a set of correlation criteria. In this example, the values of features “warehouse city” and “area code” have many overlapping, or duplicate, values. For this reason, only one of the two features is included in the subset of data when the set of correlation criteria drives the removal of duplicate features. An example correlation criterion is select only one feature of a pair of features having a similarity score of 80% or higher. Alternatively, a clarifying correlation criterion is to not consider similarity scores where the features have the same name, such as where the similarity is 1.000. That is, when the features “area code” and “area code” intersect for a 1.000 similarity rating, the subset of data features should not include one of these two features. Otherwise, the deduplication effort may be thwarted by considering two identical features for the subset of data features.

The correlation coefficient calculation is made to determine which features are highly correlated, so the perturbed record space can be reduced. The correlation coefficient value is calculated among all features to identify strongly correlated ones. For those identified as strongly correlated, values are not flipped during perturbations (perturbed records generation). The correlation coefficients are calculated based on features values. The correlation matrix is built and used for further analysis. If the space of perturbed records is still huge, simulation techniques to relax level of correlation significance can be invokes and the same reduce the perturbation space further. In other words, the significance threshold can be lowered, for example, from 0.8 to 0.7 (absolute value from correlation coefficient) if that will lead to significant reduction of perturbed records number. A series of simulations can be run to have the ability to choose the best threshold at the end and satisfy cost (number of prediction requests−scoring endpoint footprint) later on.

Processing proceeds to operation 5258, where perturbed records mod 358 generates a set of perturbed records for arbitrary indicator identification. The perturbed records mod draws from the subset of data features identified in operation 5257. Features are processed according to a range of values available to the feature. In this example, the values of the features in the subset of data features are drawn from the set of structured data without reference to external lists or a cognitive system with reference to a knowledge base. For each feature, the values present in the structured data are used to create perturbed records of the feature. In some embodiments of the present invention, available values are stored with reference to a feature for use when creating perturbed records. In some embodiments of the present invention, cognitive computing system 112 refers to domain-specific knowledge corpus 113 (FIG. 1) for determination of potential values for the various features of the subset of data features.

Processing proceeds to operation 5260, where outcome mod 360 causes the machine learning model to determine an outcome for each individual record in the structured data and the set of perturbed records. The term “individual records” refers to the records obtained from commercial proposals and the term “perturbed records” are those records having a feature value modified for evaluation of bias in the machine learning model. In this example, material acquisition model 111 receives the individual records and the set of perturbed records for analysis and determination of an outcome. In this example, the outcome is a determination of whether or not to purchase the materials according to the proposals represented by the various records. Outcome determinations are stored in data store 302 for review. Alternatively, the records processed by the machine learning model pertain to various domains in which decisions are made based on weighted preferences or based on other machine learned preference determining techniques.

Processing proceeds to operation 5262, where arbitrary indicators mod 362 identifies a set of arbitrary decision indicators. When preferences are determined according to erroneous bias, arbitrary indicators may be presented when by comparing outcomes for individual records and outcomes for similar perturbed records. In this example, processing outcome determinations to identify an arbitrary decision indicator includes sorting the records by outcome, identifying the outcome of the individual record, and identifying, for perturbed records having a different outcome, the features that were modified and the values of those features. A potential arbitrary decision indicator is present where a different outcome is determined for modified feature values. In this example, an arbitrary decision indicator is identified when pre-defined features have varied values that result in a different outcome. Accordingly, each pre-defined feature exhibiting a value-driven different outcome is identified as an arbitrary decision indicator.

Processing proceeds to operation 5264, where action mod 364 takes an action corresponding to the identification of an arbitrary decision indicator. In this example, when an arbitrary decision indicator is identified, the outcome for the individual record is cancelled and the individual record is used as input for further training of the acquisition model. In some embodiments of the present invention, the outcomes and corresponding feature values are presented to a user for evaluation. In some embodiments of the present invention, a list of modified feature values driving a different outcome is presented to a user.

### III. Further Comments and/or Embodiments

Some embodiments of the present invention may include one, or more, of the following operations, features, characteristics and/or advantages: (i) describes the method that will optimize perturbed records generation by reducing unique feature values space; (ii) uses perturbed records for bias detection, for example: (a) using a material purchasing model, the model includes the following features: supplier name, brand name, and warehouse location, and (b) as an output, the model will place orders labeled as “purchase” or will not place orders labeled as “don't purchase.” The following order dataset is submitted to the model: supplier name: ACME; brand name: Widget; warehouse location: Georgia; and average price: 100 units. In this example, the purchasing model labels the order dataset as “don't purchase.” (iii) checks if the model is biased by generating perturbed order dataset records containing other values for supplier name and other features if those are also monitored, for example a perturbated order dataset includes: supplier name: ABC Materials; brand name: Widget; warehouse location: Georgia; and average price: 100 units. if the model output for placing the order is “purchase,” this means the material purchasing model is biased and the previous recommendation was incorrect; (iv) exhibits simplification showing perturbed record generation for a single feature; and (v) if multiple features are taken into consideration, the number of perturbed records that are generated grow exponentially.

Some embodiments of the present invention may include one, or more, of the following operations, features, characteristics and/or advantages: (i) proposes usage of correlation coefficients calculated among features and feature values to reduce the volume of unique feature values (categories) before generating perturbed records; (ii) calculates the first step of the correlation matrix between features; and (iii) based on correlation coefficients, features that are highly correlated with other features can be skipped in the process of perturbed records generation.

According to an embodiment of the present invention, realistic examples of feature vectors may include, but are not limited to: (i) supplier name; (ii) shipping lead time; (iii) raw material type; (iv) brand name; (v) average price; (vi) total price; (vii) shipping cost; (viii) color; (ix) shipping service; (x) weight; (xi) area code; (xii) warehouse city; (xiii) warehouse state; and/or (xiv) country of origin.

Some embodiments of the present invention include the number of features that need to have values changed to generate perturbed records, will be reduced based on correlation coefficients (for example: the feature “area code” is significantly correlated with the feature “warehouse city,” so the feature “area code” is one of the features that can be ignored.

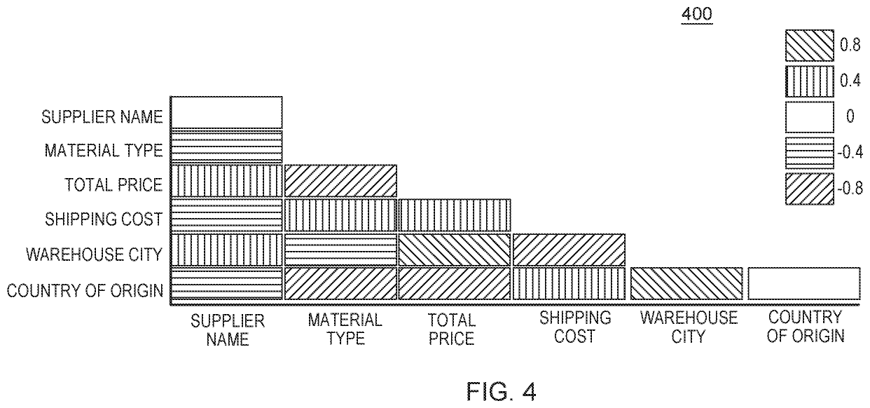

FIG. 4, chart 400 shows an example of a correlation matrix of some material acquisition features illustrating where overlap may be identified for reduced records perturbation.

Some embodiments of the present invention recognize that for each categorical feature, correlations between unique categories can be checked and those that have a high correlation from the perturbed records generated can be skipped.

Table 1 is a typical data table generated by an embodiment of the present invention. The data displayed in Table 1 shows the feature vectors described in the paragraph above verses the data in the following: (i) rows: (a) supplier name, (b) material type, (c) country of origin, (d) area code, (e) warehouse city, and (f) total price; and (ii) columns: (a) supplier name, (b) material type, (c) country of origin, and (d) warehouse city.

TABLE 1
Example Correlation Matrix

| | Supplier | Material | Country of | Warehouse |
|---|---|---|---|---|
| | Name | Type | Origin | City |
| Supplier Name | 1.000 | −0.150 | −0.391 | −0.446 |
| Material Type | −0.032 | 1.000 | 0.024 | 0.015 |
| Country of Origin | 0.039 | −0.520 | 1.000 | −0.019 |
| Area Code | −0.040 | −0.011 | 0.002 | 0.949 |
| Warehouse City | 0.056 | 0.006 | −0.068 | 1.000 |
| Total Price | −0.051 | 0.008 | 0.011 | 0.030 |

It should be noted that the data shown in FIG. 4, block chart 400 and the data shown in Table 1 above may not correlate to each other and are used only as an example embodiment of the present invention. In this example, the high correlation between the values of feature “Warehouse City” and the feature “Area Code” indicate that one of these features may substitute well for the other feature. Accordingly, where the threshold of similarity is below 0.949, the feature “Area Code” may be removed from the records for which perturbation performed. Further, for example, threshold of similarity were below −0.520, the features “material type” and “country of origin” would be considered duplicative for the purposes of data perturbation while the pair of features “warehouse city” and “supplier name” would not be consider duplicative, having a score of −0.391. It should be noted that in this example the absolute value of the score is considered for similarity.

Some embodiments of the present invention may include one, or more, of the following operations, features, characteristics and/or advantages: (i) the number of generated perturbed records can be significantly reduced leading to a lower scoring endpoint footprint; and (ii) at the same, information needed from a variation point of view is not lost, since only highly correlated feature perturbations are skipped.

A method according to an embodiment of the present invention, for feature correlation in machine learning models, includes the following operations (not necessarily in the following order): (i) obtains a set of data for processing by a machine learning model; (ii) generates, according to a set of features, a correlation matrix for the set of data; (iii) determines, according to the correlation matrix, a subset of the set of features meets a set of correlation criteria; (iv) generates a set of perturbed records for arbitrary indicator identification, wherein the set of perturbed records excludes a subset of perturbed records associated with the subset of features; (v) identifies, according to the set of perturbed records, one or more arbitrary indicators; and (vi) notifies a user of the one or more arbitrary indicators, wherein: (a) the one or more arbitrary indicators are binary features, (b) each feature of the set of features includes a data field classification within the set of data, and (c) each arbitrary indicator is associated with a unique output of the machine learning model.

Some embodiments of the present invention may include one, or more, of the following operations, features, characteristics and/or advantages: (i) reduces the number of generated records; and (ii) reduces the number of generating modified records with new distribution.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for feature correlation supporting efficient data perturbation for testing machine learning models, the method comprising:
obtaining a set of structured data including individual records having a set of data features and corresponding data values, wherein processing the set of structured data by a machine learning model results in a proposed action corresponding to an individual record;
generating a correlation matrix incorporating the set of data features and the corresponding data values;
identifying, with reference to the correlation matric, a set of data feature pairs as duplicative of one another according to a correlation criterion;
removing, from the set of data features, one data feature of each identified data feature pair to generate a reduced dataset;
generating a set of perturbed records for arbitrary indicator identification based on value variances for a target data feature of the reduced dataset, the arbitrary indicator identification being a test of the machine learning model; and.
determining, according to the set of perturbed records, a set of arbitrary indicators associated with the proposed action corresponding to the individual record.

2. The method of claim 1, further comprising:
taking the proposed action;
wherein:
the set of arbitrary indicators includes a count of indicators below a threshold count.

3. The method of claim 1, further comprising:
notifying a user of the set of arbitrary indicators;
wherein:
the set of arbitrary indicators includes a count of indicators above a threshold count.

4. The method of claim 1, wherein the set of arbitrary indicators is made up of binary features.

5. The method of claim 1, wherein each arbitrary indicator is associated with a unique output of the machine learning model when processing the individual records.

6. The method of claim 1, wherein each data feature of the set of data features includes a data field classification within the set of structured data.

7. The method of claim 1, further comprising:
identifying the value variances in a data feature table associating the at least one data feature with the value variances.

8. The method of claim 1, further comprising:
providing the at least one data feature to a cognitive system, the cognitive system including a domain-specific knowledge corpus; and
receiving from the cognitive system the value variances derived from the domain-specific knowledge corpus.

9. A computer program product for feature correlation in data perturbation, the computer program product comprising:
a set of storage device(s); and
computer code stored collectively in the set of storage device(s), with the computer code including data and instructions to cause a processor(s) set to perform at least the following operations:
obtaining a set of structured data including individual records having a set of data features and corresponding data values, wherein processing the set of structured data by a machine learning model results in a proposed action corresponding to an individual record;
generating a correlation matrix incorporating the set of data features and the corresponding data values;
identifying, with reference to the correlation matric, a set of data feature pairs as duplicative of one another according to a correlation criterion;
removing, from the set of data features, one data feature of each identified data feature pair to generate a reduced dataset;
generating a set of perturbed records for arbitrary indicator identification based on value variances for a target data feature of the reduced dataset, the arbitrary indicator identification being a test of the machine learning model; and
determining, according to the set of perturbed records, a set of arbitrary indicators associated with the proposed action corresponding to the individual record.

10. The computer program product of claim 9, further causing the processor(s) set to perform the following operation:
taking the proposed action;
wherein:
the set of arbitrary indicators includes a count of indicators below a threshold count.

11. The computer program product of claim 9, further causing the processor(s) set to perform the following operation:
notifying a user of the one or more arbitrary indicators;
wherein:
the set of arbitrary indicators includes a count of indicators above a threshold count.

12. The computer program product of claim 9, wherein the set of arbitrary indicators is made up of binary features.

13. The computer program product of claim 9, wherein data feature of the set of data features includes a data field classification within the set of structured data.

14. The computer program product of claim 9, wherein each arbitrary indicator is associated with a unique output of the machine learning model when processing the individual records.

15. The computer program product of claim 9, further causing the processor(s) set to perform the following operation:
identifying the value variances in a data feature table associating the at least one data feature with the value variances.

16. The computer program product of claim 9. further causing the processor(s) set to perform the following operations:
providing the at least one data feature to a cognitive system, the cognitive system including a domain-specific knowledge corpus; and
receiving from the cognitive system the value variances derived from the domain-specific knowledge corpus.

17. A computer system for feature correlation in data perturbation, the computer system comprising:
a processor(s) set;
a set of storage device(s); and
computer code stored collectively in the set of storage device(s), with the computer code including data and instructions to cause the processor(s) set to perform at least the following operations:
obtaining a set of structured data including individual records having a set of data features and corresponding data values, wherein processing the set of structured data by a machine learning model results in a proposed action corresponding to an individual record;
generating a correlation matrix incorporating the set of data features and the corresponding data values;
identifying, with reference to the correlation matric, a set of data feature pairs as duplicative of one another according to a correlation criterion;
removing, from the set of data features, one data feature of each identified data feature pair to generate a reduced dataset;
generating a set of perturbed records for arbitrary indicator identification based on value variances for a target data feature of the reduced dataset, the arbitrary indicator identification being a test of the machine learning model; and.
determining, according to the set of perturbed records, a set of arbitrary indicators associated with the proposed action corresponding to the individual record.

18. The computer system of claim 17, further causing the processor(s) set to perform at least the following operation:
taking the proposed action;
wherein:
the set of arbitrary indicators includes a count of indicators below a threshold count.

19. The computer system of claim 17, further causing the processor(s) set to perform at least the following operation:
notifying a user of the one or more arbitrary indicators;
wherein:
the set of arbitrary indicators includes a count of indicators above a threshold count.

20. The computer system of claim 17, further causing the processor(s) set to perform at least the following operations:
providing the at least one data feature to a cognitive system, the cognitive system including a domain-specific knowledge corpus; and
receiving from the cognitive system the value variances derived from the domain-specific knowledge corpus.
